(19) United States
(12) Patent Application Publication
(10) Pub. No.: US 2023/0027323 A1
(43) Pub. Date: Jan. 26, 2023

(54) ELECTRODE COATING USING A POROUS CURRENT COLLECTOR

(71) Applicant: GM GLOBAL TECHNOLOGY OPERATIONS LLC, DETROIT, MI (US)

(72) Inventors: Shaomao Xu, Sterling Heights, MI (US); Ryan Curtis Sekol, Grosse Pointe Woods, MI (US); Jin Liu, Novi, MI (US); Erik Damon Huemiller, Waterford, MI (US); Nicholas P. Irish, Keego Harbor, MI (US); Dmitriy Bruder, Clinton Twp, MI (US)

(21) Appl. No.: 17/380,530

(22) Filed: Jul. 20, 2021

(51) Int. Cl. H01M 4/74; H01M 4/80; H01M 4/04

(52) U.S. Cl. CPC H01M 4/742; H01M 4/808; H01M 4/0435; H01M 2004/021

(57) ABSTRACT

Aspects of the disclosure include an electrode coating having a spatially varied porosity and a method of forming the same by using a porous current collector. An exemplary method can include forming a porous current collector having a bulk material and a plurality of voids. The porous current collector can be coated, infused, or otherwise saturated with an electrode coating having an active electrode material. The porous current collector and the electrode coating can be compressed in a calendering process to define the electrode film. The distribution of the plurality of voids in the porous current collector provides for regions of different calendering pressures during the calendering process. The regions of different calendering pressures leads to regions of higher and lower porosity in the resultant electrode film. In other words, an electrode film having a spatially varied porosity.

### INTRODUCTION

The present disclosure relates to battery cell manufacturing, and particularly to an electrode coating having a spatially varied porosity and a method of forming the same by using a porous current collector.

Electrodes are widely used in a range of devices that store electrical energy, including primary (non-rechargeable) battery cells, secondary (rechargeable) battery cells, fuel cells, and capacitors. An ideal electrode needs to balance various electrical energy storage characteristics, such as, for example, energy density, power density, maximum charging rate, internal leakage current, equivalent series resistance (ESR), charge-discharge cycle durability, high electrical conductivity, and low tortuosity. Electrodes often incorporate current collectors to supplement or otherwise improve upon these electrical energy storage characteristics. Current collectors, for example, can be added to provide a higher specific conductance and can increase the available contact area to minimize the interfacial contact resistance between the electrode and its terminal.

A current collector is typically a sheet of conductive material to which the active electrode material is attached. Aluminum foil is commonly used as the current collector of an electrode. In some electrode fabrication processes, for example, a film that includes activated carbon powder (i.e., the active electrode material) is attached to a thin aluminum foil using an adhesive layer. To improve the quality of the interfacial bond between the film of active electrode material and the current collector, the combination of the film and the current collector is processed in a pressure laminator, for example, a calender. This process is generally known as calendering. Thus, the fabrication of an electrode typically involves the production of an active electrode material film and the lamination of that film onto a current collector.

### SUMMARY

Technical methods described herein include the manufacture and design of an electrode coating having a spatially varied porosity. In one exemplary embodiment, an electrode film includes a porous current collector having a bulk material and a plurality of voids. The electrode film can further include an electrode coating having an active electrode material. The porous current collector and the electrode coating can be compressed together in a calendering process to define the electrode film. In some embodiments, the electrode film includes a spatially varied porosity (e.g., regions of lower porosity and regions of higher porosity).

In some embodiments, the electrode coating fills the plurality of voids prior to calendering. In one exemplary embodiment, a distribution of the plurality of voids in the porous current collector introduces regions of different calendering pressures during the calendering process. In some embodiments, higher-pressure regions during the calendering process correspond to the lower porosity regions in the electrode film and lower-pressure regions during the calendering process correspond to the higher porosity regions in the electrode film.

In another exemplary embodiment, the porous current collector includes a mesh structure having equally sized and distributed voids. In yet other exemplary embodiments, the porous current collector includes a foam structure having a three-dimensional network of struts and pores. In still other embodiments, the plurality of voids in the porous current collector further comprise laser-patterned cut-outs. In some embodiments, the laser-patterned cut-outs have a same shape, while in other embodiments a first laser-patterned cut-out is made of a first shape and a second laser-patterned cut-out is made of a second shape different from the first shape.

Aspects of the disclosure include a method for forming an electrode coating having a spatially varied porosity. An exemplary method can include forming a porous current collector having a bulk material and a plurality of voids. The porous current collector can be coated, infused, or otherwise saturated with an electrode coating having an active electrode material. The porous current collector and the electrode coating can be compressed in a calendering process to define the electrode film. The distribution of the plurality of voids in the porous current collector provides for regions of different calendering pressures during the calendering process. The regions of different calendering pressures leads to regions of higher and lower porosity in the resultant electrode film. In other words, an electrode film having a spatially varied porosity.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIGS. 1A-1D illustrate a sequence for creating an electrode coating or film having a spatially varied porosity using a porous current collector according to one or more embodiments.

FIG. 1A depicts a porous current collector fabricated in a mesh structure having a plurality of voids.

FIG. 1B depicts a coating process whereby an electrode coating is applied to the porous current collector of FIG. 1A.

FIG. 1C depicts a calendering process whereby the electrode coating and the porous current collector of FIG. 1B are compressed between two or more oppositely situated rollers.

FIG. 1D depicts a post-calendering electrode coating.

FIG. 2 illustrates high resolution imaging data of a cross-section of an electrode coating formed from a porous current collector in accordance with one or more embodiments.

FIGS. 3A-3C illustrate a sequence for creating an electrode coating or film having a spatially varied porosity using a porous current collector according to one or more embodiments.

FIG. 3A depicts a porous current collector fabricated in a 3D foam structure.

FIG. 3B depicts a slurry coating process whereby an electrode slurry is applied to the porous current collector of FIG. 3A.

FIG. 3C depicts a post-calendering electrode coating.

FIGS. 4A-4C illustrate a sequence for creating an electrode coating or film having a spatially varied porosity using a porous current collector according to one or more embodiments.

FIG. 4A depicts a porous current collector fabricated by using a laser-patterning device to create custom cut-outs.

FIG. 4B depicts a slurry coating process whereby an electrode slurry is applied to the porous current collector of FIG. 4A.

FIG. 4C depicts a post-calendering electrode coating.

FIG. 5 is a flowchart in accordance with one or more embodiments.

### DETAILED DESCRIPTION

The following description is merely exemplary in nature and is not intended to limit the present disclosure, its application, or uses. It should be understood that throughout the drawings, corresponding reference numerals indicate like or corresponding parts and features. Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The term “a plurality” is understood to include any integer number greater than or equal to two, i.e. two, three, four, five, etc. The term “connection” can include an indirect “connection” and a direct “connection”.

As shown and described herein, various features of the disclosure will be presented. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Electrodes often incorporate current collectors to supplement or otherwise improve upon the electrical energy storage characteristics of the final integrated device (e.g., a battery). A current collector typically includes a sheet of conductive material (e.g., aluminum foil) to which an active electrode material is attached. To improve the quality of the interfacial bond between the film of the active electrode material and the current collector, the combination of the film and the current collector is processed in a pressure laminator. Thus, the fabrication of an electrode typically involves the production of an active electrode material film and the lamination of that film onto a current collector (the so-called calendering process).

Calendering can be generally defined as the compression of a dried electrode (the latter typically resulting from the coating and drying of an electrode slurry) to reduce its porosity, improve the particles contacts, and enhance its energy or power density. Conventional calendering processes have been used to improve various aspects of battery technology by offering, for example, a higher specific conductance, greater contact areas, and lower contact resistance in the electrode. There are several challenges, however, in optimizing the calendering process. One such challenge is balancing the inherent tradeoff between providing both a high electrical conductivity (requiring a low film porosity) and a low tortuosity (requiring a high film porosity) as needed for efficient ion transport.

The current calendering process is not well-suited to address this fundamental tradeoff, as notably, there is no spatial variation of the porosity of the final electrode film when using conventional calendering. The typical process takes a coating that has relatively high porosity and compresses it to a coating with reduced porosity. This is usually done with high pressure rollers that can vary pressure, roller separation, and roller temperature. The resulting coating is denser, smoother, and thinner. Moreover, the porosity is markedly uniform post-calendering. Unfortunately, while this type of electrode compression can improve several electrode properties, such as energy or power density, this same process is detrimental for other critical electrode properties, such as the effective conductivity of the electrolyte phase.

Thick electrodes enable high energy density battery designs and are a requirement for some next-generation technologies, such as, for example, high range electric vehicles. Unfortunately, conventional calendering places practical limits on the electrode film thickness. For example, thicker electrode films lead to inefficient use of active material due to the inherit tradeoff between achieving a suitably high electrical conductivity and a low tortuosity. Also, the bonding strength represents a bottleneck for achieving thick electrodes. With a high area loading of materials, the limited adhesion strength between the current collector and a thick electrode coating layer can result in an insufficient electrical contact or a poor electrode integrity. These will eventually cause a degradation of electrode performance, especially when suffering any microstructure change during cycling (charging/discharging).

One or more embodiments address one or more of the above-described shortcomings by leveraging a porous current collector to produce an electrode coating or film having a spatially varied porosity. One novel aspect of this approach is that a porous current collector introduces zones with different calendering pressures. Without wishing to be bound by theory, these calendering pressure differentials are responsible for imparting porosity variations in the final calendered coating. Electrode coatings having spatially varied porosities can directly address the inherent calendering tradeoff between providing both a high electrical conductivity and a low tortuosity in an electrode film by offering films having both regions of high porosity and regions of low porosity. Moreover, these regions can be arbitrarily allocated in the film by modifying the structure (voids/pores) of the porous current collector against which the film is created. In other words, various embodiments can employ porous current collectors having a range of constructions and geometries, such as, for example, mesh, foam, and laser-patterned current collectors, to achieve arbitrarily spatially varied porosities in the final electrode coating.

Technical solutions described herein facilitate a range of improvements to battery technology. Electrode coatings having nonuniform porosity distributions formed according to one or more embodiments can reduce battery degradation, extend battery lifetime, and improve specific capacity. In addition, arbitrarily thick electrodes are possible (the porosity of such a film can be arbitrarily manipulated as needed). This can enable, for example, the efficient construction of higher loadings in lithium ion batteries.

Other advantages are possible. From the manufacturing perspective, current calendaring presses can be easily adapted to accommodate porous current collectors, as no new rollers are needed. Instead, only a slight modification to the coating line is required, since the current collector is now porous. Another advantage is an improved bond strength between the current collector and the coating layer. For example, current calendering processes use a “sheet” style current collector, offering only a one-dimensional (1D) bonding relationship between the current collector and the coating layer. In contrast, one or more embodiments provide a three-dimensional (3D) relationship between the current collector and the coating layer due to, for example, the inner pores of the current collector.

Yet another advantage is a reduction in surface cracks and coating delamination. In a conventional calendering process heat flux can only be transferred to the bottom of the coating layer, which can cause an inhomogeneous migration of binder material at that area. Under calendering stress, the result is a 2D solid materials spreading behavior of the coating composite, which at high stress may result in surface cracks and coating delamination. Embodiments of the present disclosure alleviate these concerns, as heat flux can be efficiently transferred through the porous structure to arbitrary depths of the coating layer. Under calendering stress, the result is a 3D solid materials spreading behavior of the coating composite, and the stress can be primarily relieved through the pores, which in the end prevents or mitigates cracks and delamination. Cycling is also improved, as the 3D structure formed according to one or more embodiments significantly increases the contact area between the current collector and the coating composite, thus leading to better bonding strength and preventing delamination or detachment during cycling. This is a marked improvement over the 2D structure of the conventional calendering process, which suffers from a relatively higher potential to cause coating degradation and delamination or detachment during cycling.

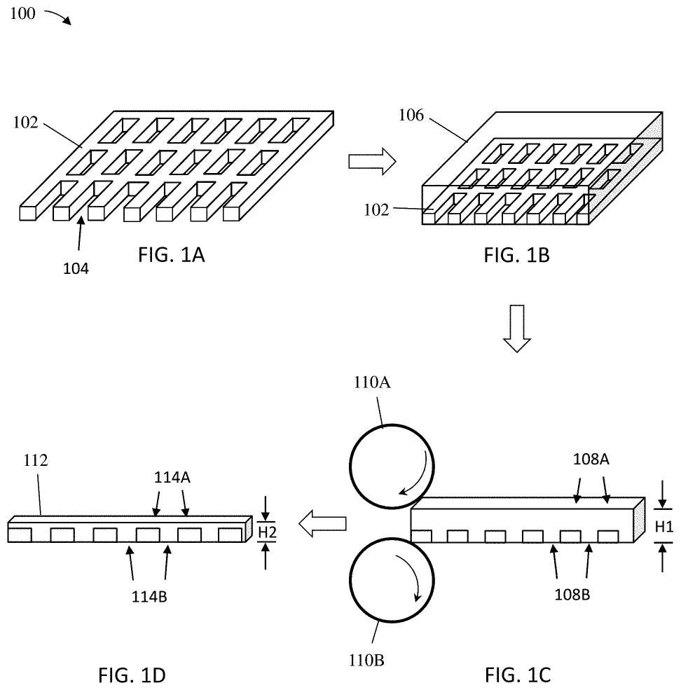

FIGS. 1A-1D illustrate a sequence 100 for creating an electrode coating or film having a spatially varied porosity using a porous current collector according to one or more embodiments. As shown in FIG. 1A, a porous current collector 102 is fabricated in a mesh structure having a plurality of voids 104. While depicted in a specific configuration for ease of illustration and discussion, the number and arrangement of the voids 104 is not meant to be particularly limited.

In some embodiments, the porous current collector 102 is configured in a mesh-like structure where the voids 104 are equally sized and evenly distributed in a symmetrical arrangement (as shown in FIG. 1A; a so-called mesh-like structure). In other embodiments, however, the voids 104 can be made such that they span a range of sizes and the voids can be distributed in an asymmetrical manner. In some embodiments, the voids can be randomly distributed. In some embodiments, the void sizes can be randomly varied. Moreover, the relative sizing between the voids 104 and the bulk material (frame) of the porous current collector 102 can be arbitrarily varied to achieve any ratio between the frame and the negative space of the porous current collector 102. The porous current collector 102 can be made of any suitable conductive material, such as, for example, patterned aluminum. Other materials are possible, such as, for example, metals (e.g., titanium), semimetals (e.g., tin, graphite), and alloys thereof.

FIG. 1B illustrates the coating process whereby an electrode coating 106 is applied to the porous current collector 102. Advantageously, the porous current collector 102 is compatible with both dry and wet electrode coating processes. In wet electrode coating embodiments, for example, active electrode materials such as graphite, silicon, and/or metal oxide (e.g., cobalt oxide) particles are mixed with a carrier fluid to form a slurry. This slurry can then be applied to the porous current collector 102 using, for example, direct coating or submersion.

As used herein, the term “active electrode material” refers to materials that enhance the function of an electrode beyond simply providing a contact point or increased reactive area. In some embodiments, for example, a film of active electrode material includes particles with high porosity, so that the surface area of the electrode exposed to an electrolyte in which the electrode is immersed is increased well beyond the area of the visible external surface. In effect, the surface area exposed to the electrolyte becomes a function of the volume of the film made from the active electrode material. A variety of suitable active electrode materials are known, such as, for example, activated carbon, conductive carbon, and graphite. Similarly, a variety of suitable carrier fluids (bulk slurry fluid) are known, such as, for example, N-methyl-2-pyrrolidone.

The size of the active electrode material particles within the slurry is not meant to be particularly limited. In some embodiments, the particle size ranges from about 0.1 to 10 microns, for example 3 microns, although other particle sizes are within the contemplated scope of the disclosure. The concentration of the active electrode material can be varied as desired for the particular application. In some embodiments, the active electrode material constitutes 20 to 80 percent by weight of the slurry (i.e., 20-80% solids), although other solids contents are within the contemplated scope of the disclosure.

In dry electrode coating embodiments, for example, the active electrode material is applied to the porous current collector 102 in the form of dry particles. In some embodiments, the dry particles are applied to the bare surface of the porous current collector 102. In some embodiments, the surface of the porous current collector 102 is pre-treated prior to application of the dry particles. Suitable activated carbon materials for dry electrode coating are available from a variety of sources known to those skilled in the art. In some embodiments, the active electrode material comprises activated carbon, conductive carbon, or graphite.

In some embodiments, a dry blend of particles (e.g., carbon) and a binder are dry mixed (fibrillized; dry-blended) to form a dry powder material. In a dry process this is typically done without the addition of liquids, solvents, processing aids, or the like to the mixture. The binder can include, for example, vinylidene polyfluoride, polyvinyl alcohol, polyimide, polyamideimide, thermoset or thermoplastic particles, and/or Polytetrafluoroethylene (PTFE), although other binders are within the contemplated scope of the disclosure.

The actual mixing process used is not meant to be particularly limited. Dry-blending may be carried out, for example, for 1 to 10 minutes in a V-blender equipped with a high intensity mixing bar, until a uniform dry mixture of dry particles and dry binder is formed. The blending time can vary based on batch size, materials, particle size, densities, as well as other properties, and yet remain within the scope of the present disclosure.

After dry-blending, the mixed dry powder material can be dry fibrillized (fibrillated) using non-lubricated high-shear force techniques. In some embodiments, high-shear forces are provided by a jet-mill. The dry powder material is introduced into the jet-mill, wherein high-velocity air jets are directed at the dry powder material to effectuate application of high shear to the fibrillizable binder within the dry powder material. The shear forces that arise during the dry fibrillization process physically stretch the fibrillizable binder, causing the binder to form a network of fibers that bind the binder to other particles in the active electrode material.

In some embodiments, application of the dry fibrillized particles can occur prior to, or be incorporated within, the calendering step. For example, the dry fibrillized particles can be applied between the rollers of a calender and the surface of the porous current collector 102. In some embodiments, one or both of the rollers is heated to improve adhesion. In embodiments having thermoset or thermoplastic particles, for example, heating one or more of the rollers can also serve to soften or liquefy the particles such that they better effectuate adhesion of the active electrode material to the porous current collector 102.

FIG. 1C illustrates the calendering process whereby the electrode coating 106 and the porous current collector 102 are compressed between two or more oppositely situated rollers (e.g., calenders). As shown in FIG. 1C, the calendering process compresses the electrode coating 106 and the porous current collector 102 from an initial height H1 to a second, reduced height H2 (see FIG. 1D). The degree of compression during calendering step can be controlled by setting the gap between the rollers 110A/B. While the degree of compression is not meant to be particularly limited, the reduced height H2 can be, for example, 20 to 70 percent of the initial height H1. In other words, the gap between the rollers 110A and 110B can be set to compress the electrode coating 106 and the porous current collector 102 to between 20 and 70 percent of its pre-calendering thickness. In some embodiments, the gap is set to compress the electrode coating 106 and the porous current collector 102 to between 45 and 55 percent of its original thickness.

As further shown in FIG. 1C, compressibility differences between the materials of the electrode coating 106 and the porous current collector 102 (i.e., the porous nature of the porous current collector 102) results in both higher-pressure regions 108A (e.g., those regions which are situated above the bulk material/frame of the porous current collector 102) and lower-pressure regions 108B (e.g., those regions which are situated in the voids 104 of the porous current collector 102) during the calendering process. The impact of these high- and low-pressure regions on the final structure will be discussed with respect to FIG. 1D.

FIG. 1D illustrates the post-calendering process whereby the electrode coating 106 and the porous current collector 102 have been compressed to a height H2 that is less than the initial height H1 (i.e., the post-calendering electrode coating). After compression, the electrode coating 106 and the porous current collector 102 together define a porous electrode film 112. As further shown in FIG. 1D, the electrode film 112 includes regions of varying porosity. Lower porosity regions 114A are formed as a result of the higher-pressure regions 108A discussed with respect to FIG. 1C. In contrast, higher porosity regions 114B are formed as a result of the lower-pressure regions 108B discussed with respect to FIG. 1C. It should be clear from FIGS. 1C and 1D that the spatial distribution of the lower porosity and higher porosity regions can be arbitrarily controlled by modifying the mesh-like structure (e.g., the void sizing, shape, placement, etc.) in the porous current collector 102. All such configurations are within the contemplated scope of the disclosure. As used herein, the term “lower porosity” as it relates to the term “higher porosity” refers to the relative difference in porosity between the two respective regions. In other words, the lower porosity regions contain a higher solids percentage than the higher porosity regions. The degree to which theses porosities differs can vary from application to application. For example, in some embodiments, the lower porosity regions contain 60 to 95 percent solids, while the higher porosity regions contain 20 to 60 percent solids.

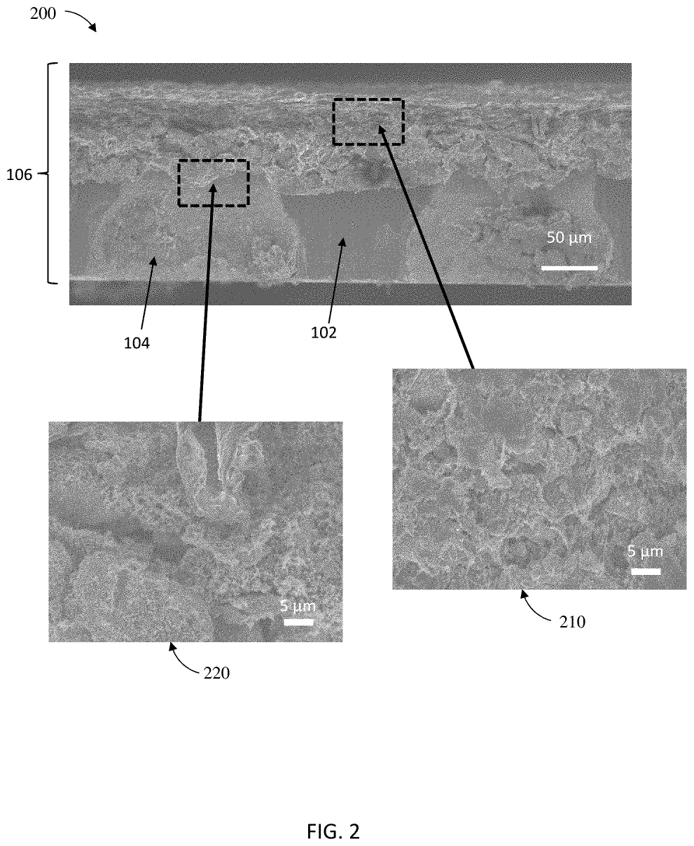

FIG. 2 illustrates high resolution imaging data 200 of a cross-section of an electrode coating 106 formed from a porous current collector 102 having one or more voids 104 post-calendering in accordance with one or more embodiments of the present disclosure. As shown in FIG. 2, the electrode coating 106 includes both lower porosity regions (e.g., lower porosity region 210) and higher porosity regions (e.g., higher porosity region 220). Although FIG. 2 illustrates one possible distribution of lower and higher porosity regions, it is, again, emphasized that any arrangement of these regions are within the contemplated scope of the disclosure.

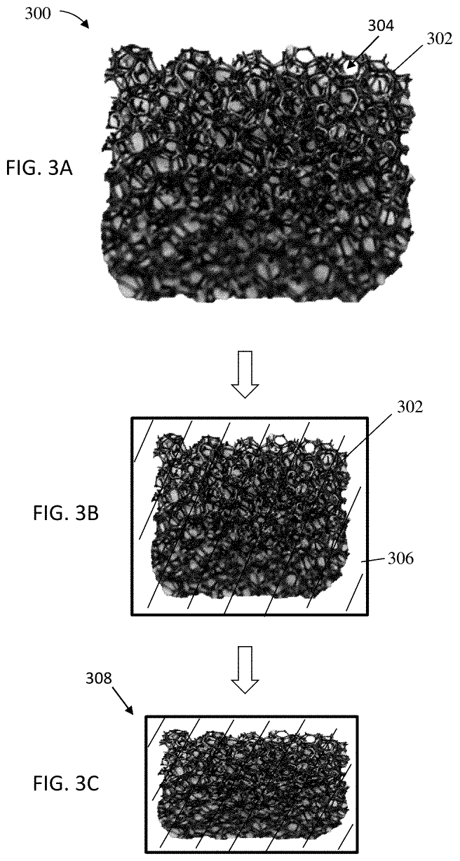

FIGS. 3A-3C illustrate a sequence 300 for creating an electrode coating or film having a spatially varied porosity using a porous current collector according to one or more embodiments. As shown in FIG. 3A, in some embodiments, a porous current collector 302 can be fabricated in a 3D foam structure having a plurality of cavities 304. The 3D foam structure can include a plurality of elements connected at a plurality of vertices in a network-like fashion. As used herein, the term “foam structure” means any reticulated pattern having a three-dimensional network of struts and pores. The 3D foam structure can be built using known materials, such as, for example, carbon foam, graphite foam, metal oxide-based foams, and various binders, and known techniques, such as by lithography or by subjecting various organic materials to carbonizing and/or graphitizing processes. Moreover, the foam structure can be made from naturally occurring and artificially derived materials. While depicted in a specific configuration for ease of illustration and discussion, the overall structure, including the number and arrangement of the cavities 304, is not meant to be particularly limited. In addition, the porous current collector 302 depicted in FIG. 3A is enlarged with respect to FIGS. 3B and 3C to better show the texture (struts, pores, etc.) of the structure.

In some embodiments, the foam may include about 4 to about 100 pores per centimeter at an average pore size of at about 1 to 50 although the particular pore size and distribution is not meant to be particularly limited. In some embodiments, for example, the average pore size can be bigger, or smaller. The average pore size and density can be modified as needed for a particular application. Reducing the average pore size will increase the effective surface area of the material but can impede or otherwise limit penetration of the active electrode material. Regardless of the average pore size, a total porosity value for the foam may be at least 10%, 20%, 30%, 40%, 50%, 60%, 70%, 80%, 90%, or 95%. In other words, at least 10%, 20%, 30%, 40%, 50%, 60%, 70%, 80%, 90%, or 95% of the foam structure may be included within the cavities 304.

FIG. 3B illustrates a slurry coating process whereby an electrode slurry 306 is applied to the porous current collector 302. In some embodiments, the electrode slurry 306 includes active electrode particles such as graphite, silicon, and/or metal oxide (e.g., cobalt oxide) mixed with a carrier fluid (e.g., N-methyl-2-pyrrolidone). The electrode slurry 306 can be applied to the porous current collector 302 using known direct coating, submersion, and/or infusion processes. The size of the active electrode particles within the slurry is not meant to be particularly limited. In some embodiments, the particle size ranges from about 0.1 to 10 microns, for example 3 microns, although other particle sizes are within the contemplated scope of the disclosure. The concentration of the active electrode material can be varied as desired for the particular application. In some embodiments, the active electrode material constitutes 20 to 80 percent by weight of the slurry (i.e., 20-80% solids), although other solids contents are within the contemplated scope of the disclosure.

FIG. 3C illustrates the post-calendering process whereby the electrode slurry 306 and the porous current collector 302 have been dried and compressed via calendering to a height H2 that is less than the initial height H1, defining a compressed three-dimensional electrode film 308. As further shown in FIG. 3C, the three-dimensional electrode film 308 includes regions of varying porosity. The distribution of lower and higher porosity regions is the result of higher and lower pressure regions, respectively, in the lattice network (struts and voids) of the porous current collector 302, in a similar manner as discussed previously with respect to FIGS. 1C and 1D. Advantageously, forming the three-dimensional electrode film 308 from a foam-type porous current collector (e.g., the porous current collector 302) results in a porosity gradient that varies in all three dimensions. In other words, a true 3D electrode structure, which has the potential to enable better fast charging performance.

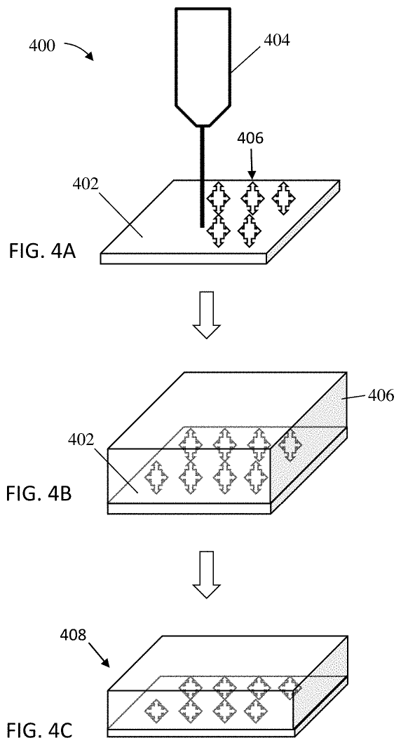

FIGS. 4A-4C illustrate a sequence 400 for creating an electrode coating or film having a spatially varied porosity using a porous current collector according to one or more embodiments. As shown in FIG. 4A, in some embodiments, a porous current collector 402 can be fabricated by using a laser-patterning device 404 to create custom cut-outs 406 (also referred to as voids or cavities) in the porous current collector 402. While depicted in a specific configuration for ease of illustration and discussion, the overall structure, including the number, arrangement, and/or shape of the cut-outs 406 is not meant to be particularly limited.

FIG. 4B illustrates a slurry coating process whereby an electrode slurry 406 is applied to the porous current collector 402. The electrode slurry 406 can be made of a similar material(s) and can be applied in a similar manner as the electrode slurry 306 discussed previously with respect to FIG. 3B. In some embodiments, the electrode slurry 406 includes active electrode particles such as graphite, silicon, and/or metal oxide (e.g., cobalt oxide) mixed with a carrier fluid (e.g., N-methyl-2-pyrrolidone). The electrode slurry 306 can be applied to the porous current collector 302 using known direct coating, submersion, and/or infusion processes.

FIG. 4C illustrates the post-calendering process whereby the electrode slurry 406 and the porous current collector 402 have been dried and compressed via calendering to define a compressed electrode film 408. As further shown in FIG. 4C, the resultant electrode film 408 includes regions of varying porosity. The distribution of lower and higher porosity regions is the result of higher and lower pressure regions, respectively, of the porous current collector 402, in a similar manner as discussed previously with respect to FIGS. 1C and 1D. Advantageously, laser treatments are capable of creating arbitrarily complex cut-out shapes, allowing for the porous current collectors (e.g., the porous current collector 402) to have any desired patterning, ensuring that the spatial variation of porosity in the resultant electrode film 408 is optimal for each application. In other words, laser treatments according to one or more embodiments can be used to fabricate electrode films having arbitrarily intricate and application-unique porosity distributions.

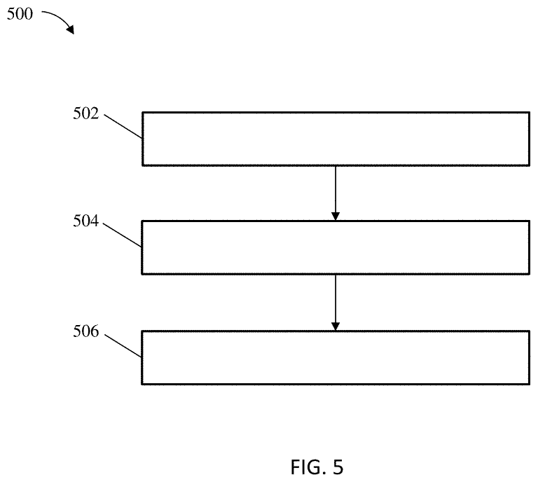

Referring now to FIG. 5, a flowchart 500 for leveraging porous current collectors to fabricate electrode films having spatially varying porosities is generally shown according to an embodiment. The flowchart 500 is described in reference to FIGS. 1A-4C and may include additional steps not depicted in FIG. 5. Although depicted in a particular order, the blocks depicted in FIG. 5 can be rearranged, subdivided, and/or combined.

At block 502, a porous current collector is formed. In some embodiments, the porous current collector includes a bulk material and a plurality of voids. In some embodiments, the porous current collector includes a mesh structure having equally sized and distributed voids (as shown in FIGS. 1A-1D). In some embodiments, the porous current collector includes a foam structure having a three-dimensional network of struts and pores (as shown in FIGS. 3A-3C). In some embodiments, the plurality of voids in the porous current collector are laser-patterned cut-outs (as shown in FIGS. 4A-4C). In some embodiments, the laser-patterned cut-outs have a same shape. In some embodiments, a first laser-patterned cut-out has a first shape and a second laser-patterned cut-out has a second shape different from the first shape.

At block 504, the porous current collector is coated with an electrode coating having an active electrode material. In some embodiments, the electrode coating fills the plurality of voids. At block 506, the porous current collector and the electrode coating are compressed in a calendering process to define the electrode film. In some embodiments, resultant the electrode film includes a spatially varied porosity. In some embodiments, the spatially varied porosity includes lower porosity regions and higher porosity regions.

In some embodiments, a distribution of the plurality of voids in the porous current collector introduces regions of different calendering pressures during the calendering process. In some embodiments, higher-pressure regions during the calendering process correspond to the lower porosity regions in the electrode film and lower-pressure regions during the calendering process correspond to the higher porosity regions in the electrode film.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope of the application.

What is claimed is:

1. An electrode film comprising:
a porous current collector comprising a bulk material and a plurality of voids; and
an electrode coating comprising an active electrode material;
wherein the porous current collector and the electrode coating are compressed together in a calendering process to define the electrode film;
wherein the electrode film comprises a spatially varied porosity.

2. The electrode film of claim 1, wherein the electrode coating fills the plurality of voids.

3. The electrode film of claim 1, wherein the spatially varied porosity comprises lower porosity regions and higher porosity regions.

4. The electrode film of claim 3, wherein a distribution of the plurality of voids in the porous current collector introduces regions of different calendering pressures during the calendering process.

5. The electrode film of claim 4, wherein higher-pressure regions during the calendering process correspond to the lower porosity regions in the electrode film and lower-pressure regions during the calendering process correspond to the higher porosity regions in the electrode film.

6. The electrode film of claim 1, wherein the porous current collector further comprises a mesh structure having equally sized and distributed voids.

7. The electrode film of claim 1, wherein the porous current collector further comprises a foam structure having a three-dimensional network of struts and pores.

8. The electrode film of claim 1, wherein the plurality of voids in the porous current collector further comprise laser-patterned cut-outs.

9. The electrode film of claim 8, wherein the laser-patterned cut-outs have a same shape.

10. The electrode film of claim 8, wherein a first laser-patterned cut-out comprises a first shape and a second laser-patterned cut-out comprises a second shape different from the first shape.

11. A method for forming an electrode film, the method comprising:
forming a porous current collector comprising a bulk material and a plurality of voids;
coating the porous current collector with an electrode coating comprising an active electrode material; and
compressing the porous current collector and the electrode coating in a calendering process to define the electrode film;
wherein the electrode film comprises a spatially varied porosity.

12. The method of claim 11, wherein the electrode coating fills the plurality of voids.

13. The method of claim 11, wherein the spatially varied porosity comprises lower porosity regions and higher porosity regions.

14. The method of claim 13, wherein a distribution of the plurality of voids in the porous current collector introduces regions of different calendering pressures during the calendering process.

15. The method of claim 14, wherein higher-pressure regions during the calendering process correspond to the lower porosity regions in the electrode film and lower-pressure regions during the calendering process correspond to the higher porosity regions in the electrode film.

16. The method of claim 11, wherein the porous current collector further comprises a mesh structure having equally sized and distributed voids.

17. The method of claim 11, wherein the porous current collector further comprises a foam structure having a three-dimensional network of struts and pores.

18. The method of claim 11, wherein the plurality of voids in the porous current collector further comprise laser-patterned cut-outs.

19. The method of claim 18, wherein the laser-patterned cut-outs have a same shape.

20. The method of claim 18, wherein a first laser-patterned cut-out comprises a first shape and a second laser-patterned cut-out comprises a second shape different from the first shape.
